(19) United States
(12) Patent Application Publication
(10) Pub. No.: US 2018/0272831 A1
(43) Pub. Date: Sep. 27, 2018

(54) METHOD AND APPARATUS FOR DETERMINING INFORMATION CONCERNING A PARTICLE LOAD IN AN AIRFLOW FLOWING INTO A VEHICLE INTERIOR

(71) Applicant: FORD GLOBAL TECHNOLOGIES, LLC, Dearborn, MI (US)

(72) Inventor: Carsten Starke, Vaals (NL)

(21) Appl. No.: 15/914,451

(22) Filed: Mar. 7, 2018

(30) Foreign Application Priority Data
Mar. 27, 2017 (DE) 102017205076.4

(51) Int. Cl. B60H 1/00; G01N 5/02; B60H 3/06; G01N 25/56

(52) U.S. Cl. CPC B60H 1/008; G01N 5/02; B60H 2001/3245; B60H 3/0608; G01N 25/56; B60H 1/00792

(57) ABSTRACT

A method is specified for determining information concerning a particle load of an airflow flowing into a vehicle interior. That method includes determining the initial mass of a filter at the start of a time interval, by means of strain gauges, passing an airflow through the filter for a time interval, determining the end mass of the filter at the end of the time interval, by means of strain gauges, ascertaining the mass difference between the end mass and the initial mass of the filter and outputting of information, based on the ascertained mass difference, concerning the particle load of the airflow. An apparatus for ascertaining information concerning a particle load of an airflow flowing into a vehicle interior is also disclosed.

### TECHNICAL FIELD

This document relates to a method and an apparatus for determining information concerning a particle load of an airflow flowing into a vehicle interior.

### BACKGROUND

Worldwide, and particularly in certain states such as, for example, China or India, air quality is an important issue for many vehicle users. Vehicles that have a closed vehicle interior are therefore equipped with filter systems for filtering the air supplied from outside, or for filtering an airflow circulating inside the vehicle.

Frequently, vehicle users wish to have information concerning the air quality in the vehicle interior, including in comparison with the air quality in the environment of the vehicle, i.e. outside the vehicle. Of particular importance in this case is the fine dust load, since the inhalation of fine dusts can have negative effects upon health. It is therefore important to ascertain whether fine dust is being adequately filtered out of the air, e.g. out of the airflow supplied from outside.

It is difficult, however, to determine low concentrations, in the range of μg/m³, by means of compact devices that can be used in vehicles. Known compact devices mostly work using a laser-based measurement method, and seek to ascertain the particle concentration on the basis of the scatter characteristics.

Scientific measurements, on the other hand, favor a so-called filter measurement, i.e. the volume of an airflow passed through a filter in a time interval, and the associated change in mass of the filter, resulting from filtered-out particles, are measured. For example, information, available on the Internet, concerning the particle load of the air is frequently based on such filter measurements, since most measurement stations are equipped with such a measurement system.

On the other hand, the hitherto available measurement system for filter measurement is not suitable for use in a vehicle, primarily because of the size of the measuring apparatus. In vehicles, therefore, expensive optical measuring devices are used, but frequently they provide imprecise measurement data and, moreover, they are highly sensitive, e.g. in respect of dirtying and clogging of the measuring cells. Furthermore, optical measuring devices require an accurate calibration. For the user, i.e., for example, the vehicle user, the underlying measurement principles and the particular measured quantities, e.g. scatter data, are not easily comprehensible, and they reduce the acceptance of such a measurement method.

### SUMMARY

It is therefore an object to specify a method and an apparatus by means of which information concerning the particle load of an airflow in a vehicle can be obtained in a simple, inexpensive and reliable manner.

This object is achieved by a method and corresponding apparatus for determining information concerning a particle load of an airflow flowing into a vehicle interior, having the features claimed.

An aspect of various embodiments of the method and apparatus is based on the recognition that the acquisition of information concerning the particle load of an airflow flowing into the interior of a vehicle can be simplified, in that the method of filter measurement is integrated into a vehicle. Provided for this purpose is the use of strain gauges, which on the one hand can be used for high-precision measurements and on the other hand are characterized by high robustness and low cost.

Strain gauges can be provided, or can be already provided, requiring only a small amount of construction and production work, on a filter, a filter holder, a filter frame, or a part of the filter. The filter mass in this case can be determined, for example, at least upon starting of the vehicle engine and upon stopping of the vehicle engine.

It can thus easily be ascertained what particle mass is filtered out of the airflow by the filter, and therefore could not pass into the lungs of the vehicle user. Already this information, considered in comparison with the otherwise often specified abstract measurement quantities or numerical values, is useful per se, since it is easily comprehensible. Moreover, in combination with a determination of the associated volume or the associated volumetric flow, the usual measurement quantities can be calculated and output.

Moreover, the service life of the filter can also be ascertained, since the filter mass and the service life of the filter correlate sufficiently with each other. Moreover, a simple calibration of the strain gauges, e.g. directly during or following their production, or following fitting in the vehicle itself, enables the accuracy of the measurement to be increased. Furthermore, by combination with the on-board computer and/or a navigation system, it is possible to generate representations of the particle load of the air, which can then be used, for example, for navigation or for other, e.g. commercial, purposes.

The advantages of the solutions according to the method and apparatus consist in their simple, inexpensive and robust design, providing very accurate and reliable information concerning the particle load. This useful information is easily comprehensible to the vehicle user and other persons, and therefore offers an improved user experience. Additional sensors and assemblies are avoided.

The method is used to ascertain information concerning the particle load of an airflow flowing in a vehicle interior. This may be the interior of a motor-operated vehicle, for example a vehicle having an internal combustion engine, e.g. a passenger vehicle.

The information relating to the particle load includes, for example, the mass concentration of the particles in the airflow, and the mass of the filtered particles, as well as further values and concentrations derived therefrom, e.g. average particle concentrations per km travelled or per operating hour of the vehicle, and assessments, e.g. particle concentration low, acceptable, too high, etc.

The airflow may preferably flow in an airflow duct, e.g. a ventilation duct. This duct may preferably serve to supply air from outside, but also to route an airflow circulating inside the vehicle. In the first case, information concerning the particle load of the air surrounding the vehicle is acquired, whereas in the second case information concerning the particle load of the air in the vehicle interior is obtained.

According to the method, the initial mass of the filter, i.e. the filter mass at the start of a time interval, is determined by means of strain gauges. For this purpose, the filter may be arranged in a freely swinging manner, for example in a filter frame. The filter may comprise a filter holder, which fixes the actual filter material, e.g. paper or a fleece material, in a particular shape.

To enable mass to be determined with greater precision, the inclination of the vehicle can also be taken into account in that, for example, information from inclination sensors arranged in the vehicle is used. It is additionally possible to use the type of suspension of the filter to calculate out a falsifying component resulting from inclination, e.g. by means of an integrated inclination measurement. Calibrating curves may be recorded, which, for example, assign a correction factor to a particular inclination, which correction factor is then taken into account in the determination of the mass by means of the strain gauges. In order to minimize the influence of the vehicle inclination, the filter may also be gimbal-mounted, or already gimbal-mounted.

For the purpose of determining mass, one or more strain gauges may be provided, wherein, in the case of a plurality of strain gauges, the mass of the filter may be determined as a mean value of the individual values determined by means of the individual strain gauges.

Following the determination of the initial mass, the airflow is passed through the filter for a time interval that is to be determined, i.e. the airflow is filtered.

At the end of the time interval, the mass of the filter (end mass) is determined again by means of strain gauges, and the mass difference between the end mass and the initial mass is ascertained. This mass difference corresponds to the mass of the filtered-out particles.

For the purpose of determining the initial and/or end mass, the airflow may be interrupted, in order to reduce or prevent a result falsification caused by the airflow.

In order to obtain only information concerning particles of a certain size class, e.g. having a particle diameter of between 0.3 μm and 10 μm, prefilters that have a greater pore size may also be used before the filter, as viewed in the direction of flow of the airflow, in order to separate out larger particles, e.g. having a particle diameter greater than 10 μm or, for example, insects.

In a final step, information concerning the particle load of the airflow, which is based on the previously ascertained mass difference, is output. For example, this may be the mass difference itself, or values or correlations derived therefrom, as described above.

The output may be effected, for example, by means of an optical display or an acoustic signal. There is also the possibility that the information is output only under certain conditions, e.g. that an optical or acoustic signal is output only in the case of an increased particle load or a particle load that is hazardous to health.

Moreover, the determined filter mass may be used to estimate the service life of the filter. If, for example, the filter mass exceeds a defined limit value, the filter should be replaced, as it is clogged and an adequate filtering performance can no longer be ensured.

According to various embodiment variants, the volume of the airflow passed through the filter within the time interval may also be determined, for example in that the volumetric flow is measured and the associated volume is determined from the length of the time interval.

From the volume and the mass difference, it is then possible to ascertain the particle mass concentration, as a ratio of the mass difference to the volume passed through. Then, for example, the particle mass concentration itself, values derived therefrom or correlations derived therefrom can then be output as information, concerning the particle load of the airflow, that is based on the ascertained particle mass concentration.

For example, there is also the possibility that an average particle size can be estimated from the pressure loss across the filter and from the mass. By means of previous measurement values, the current increase can also be estimated therefrom. Such derived values or correlations may also be transmitted, for example, to an external processing unit, which may be cloud-based, for example, and evaluated there.

According to further embodiment variants, the initial mass may be determined upon starting of a vehicle engine, and/or the end mass may be determined upon stopping of a vehicle engine. For example, this may be linked to an automatic start/stop system of the vehicle engine to enable a greater number of measurement values to be generated, such that the information ultimately obtained can more accurately correspond to the actual conditions.

According to further embodiment variants, the vehicle location may additionally be determined, and the information relating to the particle load correlated with the vehicle location. The determination of the vehicle location may be effected, for example, by means of a global navigation satellite system such as, for example, GPS, GLONASS, Beidou or Galileo. The information correlated with the vehicle location may be stored, for example, in an internal database, or transmitted from the vehicle, e.g. to an external database or an external processing unit.

There is also the possibility of compiling and outputting a location-related representation of the information concerning the particle load. This, likewise, may be effected in the vehicle itself or externally. A plurality of location-related items of information concerning the particle load may also be combined for the representation.

According to further embodiment variants, the humidity of the airflow, i.e. the air humidity, may be determined, e.g. by means of known hygrometers, before the airflow passes through the filter. This offers the possibility of ascertaining and taking account of the influence of the air humidity upon the result of the determination of mass, e.g. by means of previously compiled calibrating curves. Alternatively, the airflow may be dried before it is passed through the filter, i.e. before the filter in the direction of flow. Moreover, there is also the possibility of drying the filter itself before the mass is determined, in order to minimize the influence of the air humidity upon the determination of mass.

According to further embodiment variants, the airflow may be passed through a fine-dust filter, in order to filter out particles having a particle diameter from 0.3 μm. For example, a filter of the filter classes F7 to F9 according to DIN EN 779:2012-10 may be used.

An apparatus for ascertaining information concerning a particle load of an airflow flowing into a vehicle interior has an airflow duct, a filter arranged in the airflow duct, and means for determining the mass of the filter having strain gauges. Also provided are a processing unit, which is designed to ascertain a mass difference of the filter, and which may additionally be designed to derive information concerning the particle load of the airflow, and an output unit for outputting information, based on the ascertained mass difference, concerning the particle load of the airflow.

The apparatus is suitable, for example, for executing the method explained above. To that extent, the above statements explaining the method also serve to describe the apparatus.

The filter may be composed, for example, of paper, a textile material, e.g. a fleece, or a ceramic material. To enlarge the surface, the filter may be realized as a plate-type filter, in which case the plates form a plate pack and may be arranged, for example, in a freely swinging manner in a filter frame, i.e. with a gap with respect to the filter frame.

Preferably, the filter may be arranged in such a manner in the airflow duct that it closes the latter as tightly as possible, i.e. the leakage airflow should be the least possible. A greatest possible sealing effect may be achieved, for example, by suitable dimensioning and choice of material for the filter frame, the filter and the suspension, as a result of which the gap between the filter and the frame can be closed, at least partly, by the higher air pressure in the filter, which minimizes the leakage airflow and enables a better filtering effect to be achieved.

The pressure loss across the filter may be of such a magnitude, for example, that the resultant force displaces (FIG. 2, 3) or deforms (FIG. 4) the filter frame or parts of the filter frame, in order to effect as tight a seal as possible by means of the filter, e.g. the filter holder thereof. This sealing effect may be improved by the choice of a suitable material and/or a suitable geometry, e.g. by rubber lips, which may be fitted, for example, on the side of the filter frame that faces toward the filter. A suitable choice of material in the region of the suspension can improve the deformation or displacement. The material and porosity of the filter can support the pressure loss. As soon as the pressure loss, or the force, is sufficient to close the gap, the pressure loss and the associated, resultant force are increased and maintain the sealing effect.

There is also the possibility of designing the filter, e.g. the filter holder thereof, and/or the filter frame in such a way that the filter is arranged in a freely swinging manner only during the determination of mass, and otherwise bears tightly against the filter frame, in order to minimize or prevent a leakage airflow.

The output unit of the apparatus may be suitable, for example, for acoustic or optical signaling of information based on the mass difference, and may be realized, for example, as a display.

The processing unit of the apparatus may be arranged internally, i.e. inside the vehicle, or externally, i.e. outside the vehicle, e.g. in a central server unit. In the latter case, a transmitting and receiving apparatus may additionally be provided, to enable data or information to be transferred. The apparatus may additionally comprise a storage unit, e.g. for storing previously determined filter masses or derived information.

According to various embodiment variants, the apparatus has a means for ascertaining the volumetric flow flowing through the filter. In this case, the processing unit may furthermore be designed to determine the particle mass concentration as a ratio of the mass difference to the passed-through volume, and optionally to derive information on the basis of the particle mass concentration. According to further embodiment variants, the apparatus has a means for determining the vehicle location, for example a means for using a global navigation satellite system. In this case, the processing unit may furthermore be designed to correlate the information concerning the particle load with the vehicle location.

Optionally, the processing unit may additionally be designed to compile a location-related representation of the particle load, in that a plurality of items of information concerning the particle load are combined. The output unit in this case may be designed to output the location-related representation of the particle load. In addition, a receiving and/or transmitting apparatus may be provided, which transmits the filter masses and/or location-related information to an additional, external processing and/or storage unit, or receives derived information from an external processing unit.

According to further embodiment variants, the apparatus may have a hygrometer, for determining the air humidity, which is arranged before the filter as viewed in the direction of flow of the airflow. As described above, this enables the air humidity to be taken into account in the determination of mass. Optionally, there may also be a means for drying the airflow, which dries the airflow before the latter reaches the filter, i.e. which reduces the air humidity until a maximum air humidity, which is to be defined, is reached.

According to further embodiment variants, the filter may be realized as a fine-dust filter, e.g. as a filter of the filter class F7 to F9 according to DIN EN 779:2012-10.

### BRIEF DESCRIPTION OF THE DRAWING FIGURES

The method and apparatus are now to be explained in greater detail in the following on the basis of exemplary embodiments. The associated drawings show:

FIG. 1 is a schematic representation of a filter of the current apparatus;

FIGS. 2-4 are schematic partial views of a filter of an apparatus according to reduce the leakage airflow.

### DETAILED DESCRIPTION

In the examples explained in the following, reference is made to the appended drawings, which constitute a part of the example and in which there are shown, for the purpose of illustration, specific embodiments in which the new method and apparatus may be realized. It is understood that other embodiments may be used, and structural or logical changed may be effected, without departure from the protective scope of the present method and apparatus. It is understood that the features of the various exemplary embodiments described herein may be combined with one another, unless otherwise specified. The following description is therefore not to be construed in a limiting sense, and the protective scope of the present method and apparatus is defined by the appended claims. In the figures, elements that are identical or similar are denoted by identical references, insofar as expedient.

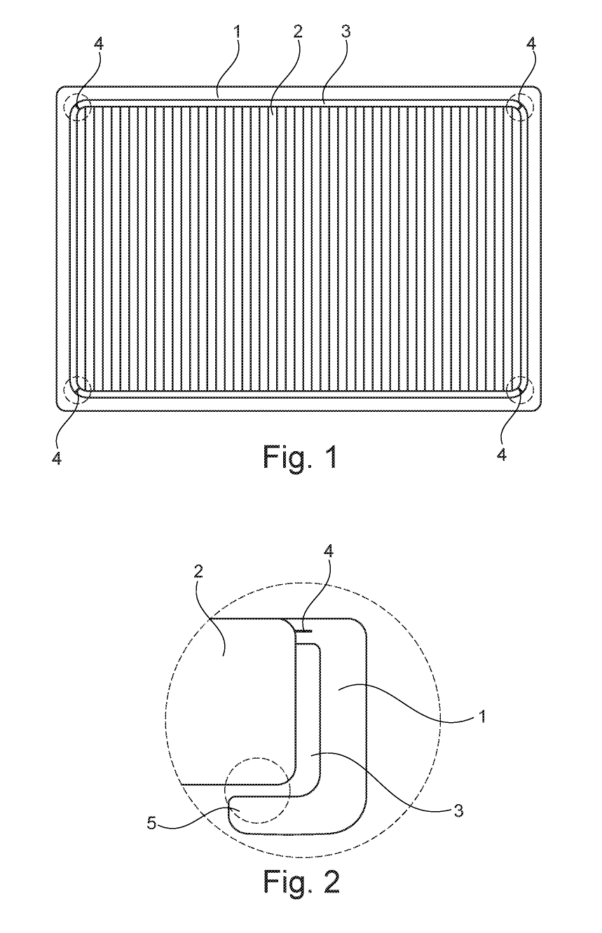

FIG. 1 shows a filter 2 of the apparatus for ascertaining information concerning a particle load of an airflow flowing into a vehicle interior. The filter 2 consists of a filtering plate pack, and is arranged in a rectangular filter frame 1.

The filter frame 1 is fixed in an airflow duct of a passenger vehicle that serves to ventilate the vehicle interior with air supplied from outside (not represented). The filter 2 is fastened in the filter frame 1 by means of four filter suspensions 4, which are located in the corners of the filter frame 1, and there are strain gauges, which serve to determine the mass of the filter, integrated into the filter suspensions 4.

Formed between the filter frame 1 and the filter 2 there is a gap 3, which is sufficiently large to allow free swinging of the plate pack, but so small that no significant leakage airflow is produced.

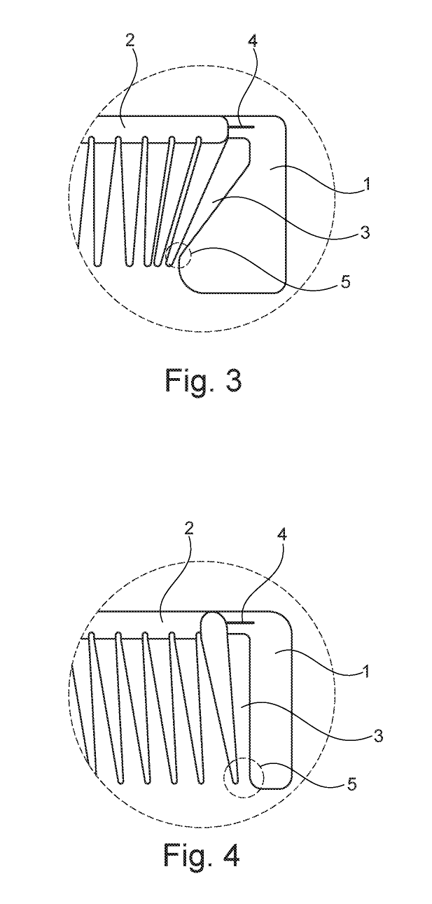

FIGS. 2 to 4 show details of embodiment variants, namely, respectively, a corner of the filter frame 1 with a filter 2 and filter suspensions. Here, the sealing effect during operation is provided in that, in a region 5, as a result of appropriate dimensioning and choice of material of the filter frame 1, the plate pack of the filter 2 and the filter suspensions 4, a region 5 present in the gap 3 is closed, or sealed, reducing the leakage airflow and allowing a better filtering effect. The resulting force caused by the pressure loss across the filter can displace (FIG. 2, 3) or deform (FIG. 4) the filter frame or parts of the filter frame, in order to close the filter as tightly as possible.

As shown by FIG. 2, the filter frame 1 also goes around the plate pack of the filter 2, such that a better sealing effect is achieved. As shown by FIG. 3, the filter frame 1 is realized in part with a thickened portion, in order to reduce the distance from the filter 2, and thereby to reduce the leakage airflow. As shown by FIG. 4, the filter plates are shaped such that the gap between the filter frame 1 and the filter 2 is as small as possible.

What is claimed:

1. A method for determining information concerning a particle load of an airflow flowing into a vehicle interior, comprising:
determining an initial mass of a filter at a start of a time interval, by means of strain gauges;
passing the airflow through the filter for the time interval;
determining, by strain gauges, an end mass of the filter at an end of the time interval;
ascertaining a mass difference between the end mass and the initial mass of the filter; and
outputting of information, based on the mass difference, concerning the particle load of the airflow.

2. The method as claimed in claim 1, further including:
determining a volume of the airflow passed through the filter within the time interval;
determining a particle mass concentration as a ratio of the mass difference to a passed-through volume; and
outputting of information, based on the particle mass concentration, concerning the particle load of the airflow.

3. The method as claimed in claim 2, further including determining the initial mass upon starting of a vehicle engine, and/or determining the end mass upon stopping of the vehicle engine.

4. The method as claimed in claim 3, further including:
determining a vehicle location; and
correlating the information concerning the particle load with the vehicle location.

5. The method as claimed in claim 4, further including:
compiling and outputting a location-related representation of the information concerning the particle load.

6. The method as claimed in claim 5, further including:
determining humidity of the airflow before the airflow is passed through the filter.

7. The method as claimed in claim 6, further including:
drying the airflow before the airflow is passed through the filter.

8. The method as claimed in claim 7, further including passing the airflow through a fine-dust filter.

9. The method as claimed in claim 1, further including determining the initial mass upon starting of a vehicle engine, and/or determining the end mass upon stopping of the vehicle engine.

10. The method as claimed in claim 1, further including:
determining a vehicle location; and
correlating the information concerning the particle load with the vehicle location.

11. The method as claimed in claim 1, further including:
compiling and outputting a location-related representation of the information concerning the particle load.

12. The method as claimed in claim 1, further including:
determining humidity of the airflow before the airflow is passed through the filter.

13. The method as claimed in claim 1, further including:
drying the airflow before the airflow is passed through the filter.

14. An apparatus for ascertaining information concerning a particle load of an airflow flowing into a vehicle interior, comprising:
an airflow duct;
a filter arranged in the airflow duct;
a strain gauge for determining a mass of the filter;
a processing unit, configured to ascertain a mass difference of the filter; and
an output unit for outputting information, based on the ascertained mass difference, concerning the particle load of the airflow.

15. The apparatus as claimed in claim 14, furthermore having:
a means for determining a volumetric flow flowing through the filter, wherein the processing unit is furthermore configured to determine a particle mass concentration as a ratio of the mass difference to a passed-through volume.

16. The apparatus as claimed in claim 14, furthermore having:
a global navigation satellite system for determining the vehicle location, wherein the processing unit is furthermore configured to correlate the information concerning the particle load with the vehicle location.

17. The apparatus as claimed in claim 16, wherein the processing unit is furthermore configured to compile a location-related representation of the particle load, and wherein the output unit is configured to output the location-related representation of the particle load.

18. The apparatus as claimed in claim 17, furthermore having:
a hygrometer, for determining humidity of the airflow, said hygrometer being arranged upstream of the filter.

19. The apparatus as claimed in claim 14, furthermore having:
a dryer for drying the airflow.

20. The apparatus as claimed in claim 14, wherein the filter is realized as a fine-dust filter.
